(19) United States
(12) Patent Application Publication
(10) Pub. No.: US 2007/0041596 A1
(43) Pub. Date: Feb. 22, 2007

(54) Condenser microphone

(76) Inventors: David Pan, Hsin-Tien City (TW); William Chang, Hsin-Tien City (TW); Jack Chang, Hsin-Tien City (TW)

Correspondence Address: HARNESS, DICKEY & PIERCE, P.L.C., P.O. BOX 8910, RESTON, VA, 20195, US

(21) Appl. No.: 11/199,164

(22) Filed: Aug. 9, 2005

(51) Int. Cl. H04R 25/00

(52) U.S. Cl. 381/174

(57) ABSTRACT

A condenser microphone includes: a casing including a peripheral wall that has a top end and a bottom end defining a bottom opening, and a flange that is bent inwardly from the top end of the peripheral wall; a substrate having an inner surface that is attached to the bottom end, that covers the bottom opening, and that cooperates with the peripheral wall and the flange to define an accommodating space thereamong; a diaphragm-and-ring assembly disposed in the accommodating space; a spacer disposed in the accommodating space between the diaphragm-and-ring assembly and the inner surface of the substrate; and a backplate.

### BACKGROUND OF THE INVENTION

1. Field of the Invention

This invention relates to a condenser microphone, more particular to a condenser microphone including a casing with a peripheral wall and a flange that is bent from the peripheral wall to retain a diaphragm-and-ring assembly in the casing.

2. Description of the Related Art

U.S. Pat. No. 6,654,473 discloses a condenser microphone (see FIG. 1) that includes a cup-shaped casing 10 having a peripheral wall 101 and an opening 100, a diaphragm-and-ring assembly 11, a backplate 12, means disposed between the backplate 12 and the diaphragm-and-ring assembly 11, a microphone circuit board 13 closing the opening 100, and a spacer 14 disposed between the microphone circuit board 13 and a peripheral edge of the diaphragm-and-ring assembly 11. The peripheral wall 101 has a top edge that is rolled to form a flange 102 which urges the microphone circuit board 13 toward a base 103 of the casing 10.

The aforesaid condenser microphone is disadvantageous in that the microphone circuit board 13 is entirely received in the casing 10 and that the flange 102 is in contact with an outer surface 131 of the microphone circuit board 13 and cooperates with the outer surface 131 of the microphone circuit board 13 to form a U-shaped recess 105 therebetween. As a consequence, the microphone circuit board 13 cannot be bonded to an external circuit board (not shown) through surface mounting technology (SMT). Moreover, the flange 102 undesirably increases the height (h) of the condenser microphone.

### SUMMARY OF THE INVENTION

Therefore, the object of the present invention is to provide a condenser microphone that is capable of overcoming at least one of the aforementioned drawbacks of the prior art.

According to the present invention, there is provided a condenser microphone that includes: a casing including a peripheral wall that has a top end and a bottom end which is opposite to the top end and which defines a bottom opening, the casing further including a flange that is bent inwardly from the top end of the peripheral wall; a substrate having an inner surface that is attached to the bottom end, that covers the bottom opening, and that cooperates with the peripheral wall and the flange to define an accommodating space thereamong; a diaphragm-and-ring assembly disposed in the accommodating space adjacent to the flange; a spacer disposed in the accommodating space between the diaphragm-and-ring assembly and the inner surface of the substrate and in contact with the diaphragm-and-ring assembly and the inner surface of the substrate; and a backplate disposed between the substrate and the diaphragm-and-ring assembly and surrounded by the spacer.

### BRIEF DESCRIPTION OF THE DRAWINGS

In the drawings which illustrate an embodiment of the invention,

FIG. 1 is a schematic view of a conventional condenser microphone;

FIG. 2 is a schematic sectional view of the preferred embodiment of a condenser microphone according to the present invention adapted for coupling to an external printed circuit board; and

FIG. 3 is an exploded perspective view of the preferred embodiment.

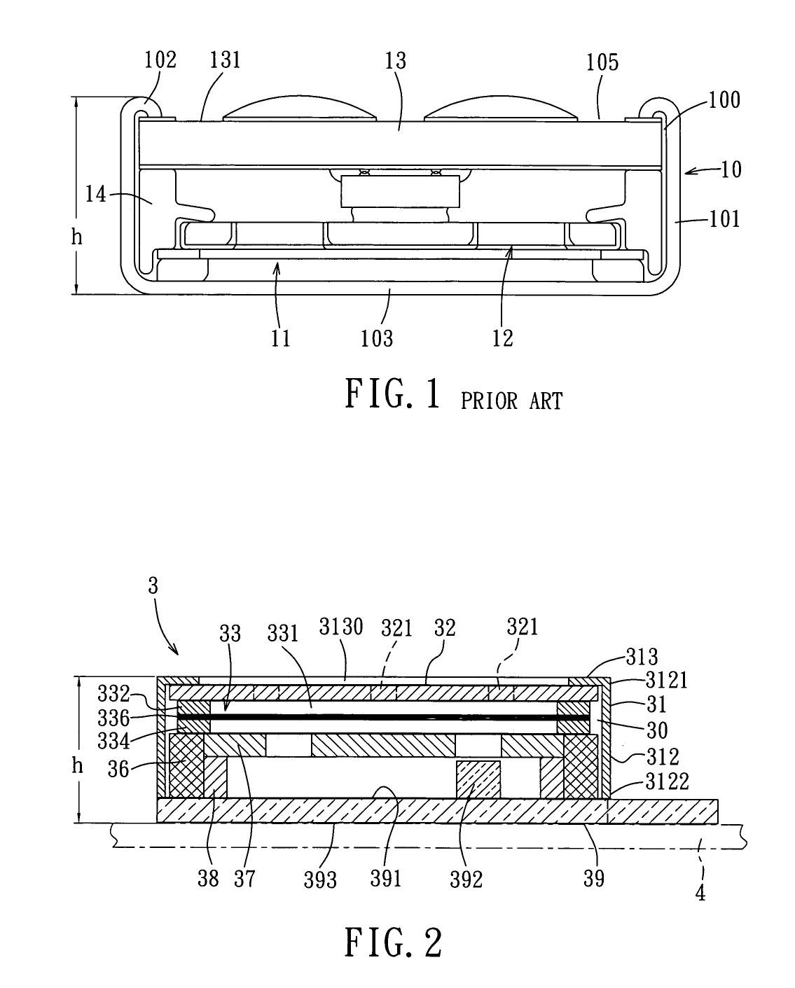

### DETAILED DESCRIPTION OF THE PREFERRED EMBODIMENT

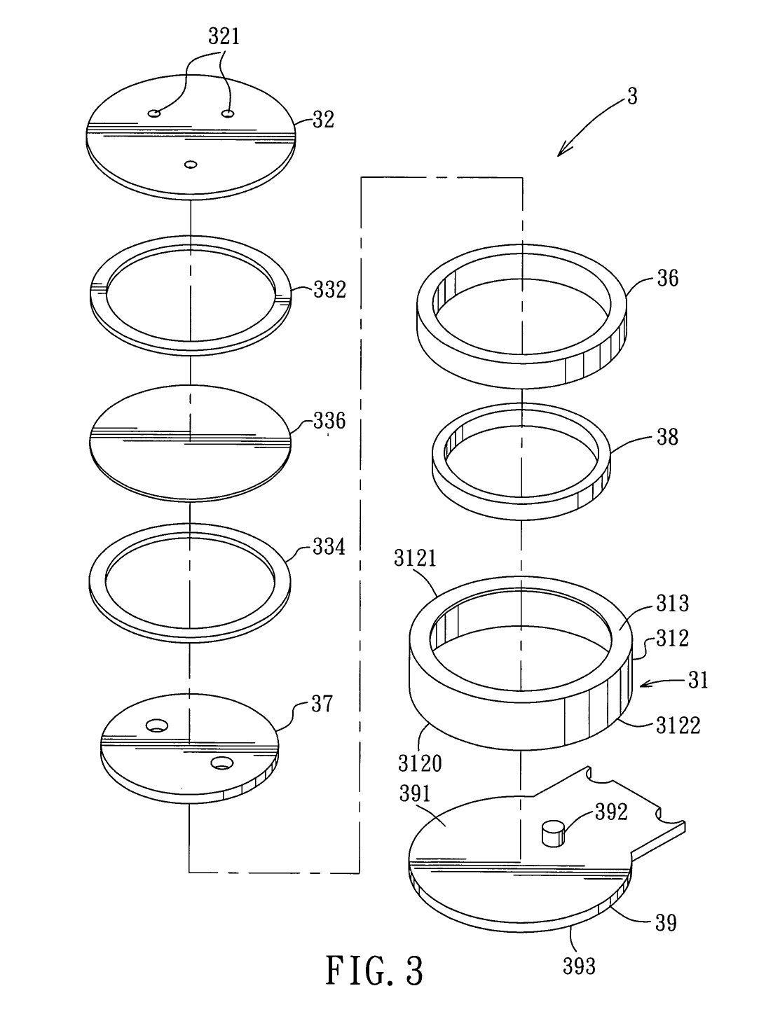

FIGS. 2 and 3 illustrate the preferred embodiment of a condenser microphone 3 according to this invention adapted for coupling to an external printed circuit board 4.

The condenser microphone 3 includes: a casing 31 including a peripheral wall 312 that has a top end 3121 and a bottom end 3122 which is opposite to the top end 3121 and which defines a bottom opening 3120, the casing 31 further including a flange 313 that is bent inwardly from the top end 3121 of the peripheral wall 312; a substrate 39 having an inner surface 391 that is attached to the bottom end 3122, that covers the bottom opening 3120, and that cooperates with the peripheral wall 312 and the flange 313 to define an accommodating space 30 thereamong; a diaphragm-and-ring assembly 33 disposed in the accommodating space 30 adjacent to the flange 313; a spacer 36 disposed in the accommodating space 30 between the diaphragm-and-ring assembly 33 and the inner surface 391 of the substrate 39 and in contact with the diaphragm-and-ring assembly 33 and the inner surface 391 of the substrate 39; and a backplate 37 disposed between the substrate 39 and the diaphragm-and-ring assembly 33, surrounded by the spacer 36, and coupled electrically to the substrate 39 through a conductive body 38.

In this embodiment, a cover plate 32 is disposed between the flange 313 and the diaphragm-and-ring assembly 33, and cooperates with the diaphragm-and-ring assembly 33 to define a gap 331 therebetween. The flange 313 defines a top opening 3130 opposite to the bottom opening 3120. The cover plate 32 covers the top opening 3130, and is formed with a plurality of apertures 321 in fluid communication with the gap 331. The diaphragm-and-ring assembly 33 and the cover plate 32 are urged by the flange 313 toward the substrate 39 such that the spacer 36 abuts against the substrate 39, thereby retaining the diaphragm-and-ring assembly 33, the cover plate 32, and the spacer 36.

The diaphragm-and-ring assembly 33 includes upper and lower washers 332, 334 and a diaphragm 336 disposed between the upper and lower washers 332, 334. The upper and lower washers 332, 334 are in contact with a peripheral edge of the cover plate 32 and the spacer 36, respectively.

The substrate 39 is a microphone circuit board, and includes a signal generating component 392 mounted on the inner surface 391 of the substrate 39. The substrate 39 further has an outer surface 393 opposite to the inner surface 391 and disposed at an exterior of the casing 31, thereby permitting surface mounting of the condenser microphone 3 to the external printed circuit board 4.

In operation, when sound waves pass through the apertures 321 in the cover plate 32 and enter into the gap 331, the diaphragm 336 vibrates correspondingly, and the backplate 37 generates a current corresponding to the frequency and amplitude of the vibration of the diaphragm 336. The signal generating component 392 of the substrate 39 generates a signal corresponding to the current, and sends the signal to the external printed circuit board 4.

When the height of the assembly of the diaphragm-and-ring assembly 33, the spacer 36, and the substrate 39 of the condenser microphone 3 of this invention is the same as that of the aforesaid conventional condenser microphone, the casing 31 of the condenser microphone 3 of this invention can have a height less than that of the casing of the aforesaid conventional condenser microphone since the substrate 39 is not accommodated in the casing 31. As such, the height (h) of the condenser microphone 3 of this invention can be made smaller than the aforesaid conventional condenser microphone. Moreover, the substrate 39 permits mounting of the condenser microphone 3 on the external printed circuit board 4 using SMT.

With the invention thus explained, it is apparent that various modifications and variations can be made without departing from the spirit of the present invention. It is therefore intended that the invention be limited only as recited in the appended claims.

What is claimed is:

1. A condenser microphone comprising:
a casing including a peripheral wall that has a top end and a bottom end which is opposite to said top end and which defines a bottom opening, said casing further including a flange that is bent inwardly from said top end of said peripheral wall;
a substrate having an inner surface that is attached to said bottom end, that covers said bottom opening, and that cooperates with said peripheral wall and said flange to define an accommodating space thereamong;
a diaphragm-and-ring assembly disposed in said accommodating space adjacent to said flange;
a spacer disposed in said accommodating space between said diaphragm-and-ring assembly and said inner surface of said substrate and in contact with said diaphragm-and-ring assembly and said inner surface of said substrate; and
a backplate disposed between said substrate and said diaphragm-and-ring assembly and surrounded by said spacer.

2. The condenser microphone of claim 1, further comprising a cover plate disposed between said flange and said diaphragm-and-ring assembly, said flange defining a top opening opposite to said bottom opening, said cover plate covering said top opening and being formed with a plurality of apertures.

3. The condenser microphone of claim 2, wherein said substrate is a microphone circuit board.

4. The condenser microphone of claim 3, wherein said diaphragm-and-ring assembly includes upper and lower washers and a diaphragm disposed between said upper and lower washers, said upper and lower washers being in contact with said cover plate and said spacer, respectively.
